(19) United States
(12) Patent Application Publication
(10) Pub. No.: US 2013/0173842 A1
(43) Pub. Date: Jul. 4, 2013

(54) Adaptive Logical Group Sorting to Prevent Drive Fragmentation

(71) Applicants: King Ying Ng, Fremont, CA (US); Marielle Bundukin, Hayward, CA (US); Paul A. Lassa, Cupertino, CA (US); Sergey A. Gorobets, Edinburgh (GB); Liam Parker, Edinburgh (GB)

(72) Inventors: King Ying Ng, Fremont, CA (US); Marielle Bundukin, Hayward, CA (US); Paul A. Lassa, Cupertino, CA (US); Sergey A. Gorobets, Edinburgh (GB); Liam Parker, Edinburgh (GB)

(21) Appl. No.: 13/338,941

(22) Filed: Dec. 28, 2011

(51) Int. Cl. G06F 12/00

(52) U.S. Cl. 711/103; 711/E12.008

(57) ABSTRACT

A method and system are disclosed for controlling the storage of data in a storage device to reduce fragmentation. The method may include a controller of a storage device receiving data for storage in non-volatile memory and determining if a threshold amount of data has been received. When the threshold amount of data is received, the non-volatile memory is scanned for sequentially numbered logical groups of data previously written in noncontiguous locations in the non-volatile memory. When a threshold amount of such sequentially numbered logical groups is found, the controller re-writes the sequentially numbered logical groups of data contiguously into a new block. The system may include a storage device with a controller configured to perform the method noted above, where the thresholds for scanning the memory for fragmented data and removing fragmentation by re-writing the fragmented data into new blocks may be fixed or variable.

### TECHNICAL FIELD

This application relates generally to a method and system for managing the storage of data in a data storage device.

### BACKGROUND

Non-volatile memory systems, such as flash memory, are used in digital computing systems as a means to store data and have been widely adopted for use in consumer products. Flash memory may be found in different forms, for example in the form of a portable memory card that can be carried between host devices or as a solid state disk (SSD) embedded in a host device. These memory systems typically work with data units called “pages” that can be written, and groups of pages called “blocks” that can be read and erased, by a storage manager often residing in the memory system.

A non-volatile memory system may develop problems with efficiency as it becomes more filled with data. Over time, data associated with sequential logical addresses can become scattered over different physical locations in the memory. This fragmentation of the data within a memory system can lead to delays in response time for the memory system as the memory fills up because fewer free blocks may be available for incoming data and the memory system may then need to attend to housekeeping operations to free up more space. The housekeeping operations require more effort by the memory system when the data that is made obsolete by incoming updated data is scattered over multiple different blocks.

### BRIEF SUMMARY

In order to address the problems and challenges noted above, a system and method for handling host write commands to reduce fragmentation is disclosed.

According to a first aspect, a method for controlling storage of content on a storage device is disclosed. The method includes, in a storage device having a controller in communication with non-volatile memory, receiving data for storage in the non-volatile memory and determining if a threshold amount of data has been received. If the threshold amount of data has been received, the non-volatile memory is scanned for sequentially numbered logical groups of data previously written in noncontiguous locations in the non-volatile memory. If a threshold amount of sequentially numbered logical groups previously written in noncontiguous locations are present, that threshold amount of sequentially numbered logical groups of data is contiguously re-written into an available new block in the non-volatile memory. In various alternative implementations, the threshold amount of data received may be a fixed, preset amount of data. The threshold amount of sequentially numbered logical groups previously written in noncontiguous locations may also be a fixed, preset amount of logical groups of data. Alternatively, one or both of the threshold amounts may be a variable amount, where the variability may be based on the state of the non-volatile memory, such as the fullness of the non-volatile memory. According to another aspect, a storage device is disclosed having a non-volatile memory and a controller in communication with the non-volatile memory that is configured to carry out the adaptive sorting of logical groups set out above.

In yet another aspect, method of controlling storage of content on a storage device is disclosed. The method includes, in a storage device having a non-volatile memory and a controller in communication with the non-volatile memory, receiving data to be written to the non-volatile memory, incrementing a data write counter an amount corresponding to the received data to be written, and scanning the non-volatile memory for sequentially numbered, but discontiguously located, logical groups when the data write counter reaches or exceeds a scan threshold amount. If a number of sequentially numbered, but discontiguously located, logical groups identified by scanning the non-volatile memory is at least equal to a contiguous write threshold, the identified logical groups are copied sequentially and contiguously into a new block in the non-volatile memory. The sequentially numbered logical groups are invalidated in their respective original blocks after copying the sequentially numbered logical groups contiguously into the new block. In alternative embodiments, one or both of the thresholds of data received or the contiguous write threshold may be increased or decreased based on a parameter relating to the non-volatile memory, such as fullness of the non-volatile memory.

### BRIEF DESCRIPTION OF THE DRAWINGS

FIG. 1 illustrates a block diagram of a storage device and host according to one embodiment.

FIG. 2 illustrates an example physical memory organization of a memory bank of FIG. 1.

FIG. 3 shows an expanded view of a portion of the physical memory of FIG. 2.

FIGS. 4A-4G illustrate an example sequence of data write and housekeeping operations in a memory that is not pre-sorted by logical groups.

FIGS. 5A-5C illustrates an example sequence of data write and housekeeping operations in a memory that is pre-sorted by logical groups.

FIG. 6 is a flow chart of one method of controlling storage of content to sort logical groups.

FIG. 7 is a flow chart illustrating an alternative embodiment of the method illustrated in FIG. 6.

FIG. 8 is a table for varying different thresholds used in the embodiment of the process of sorting logical groups of FIG. 7.

### DETAILED DESCRIPTION

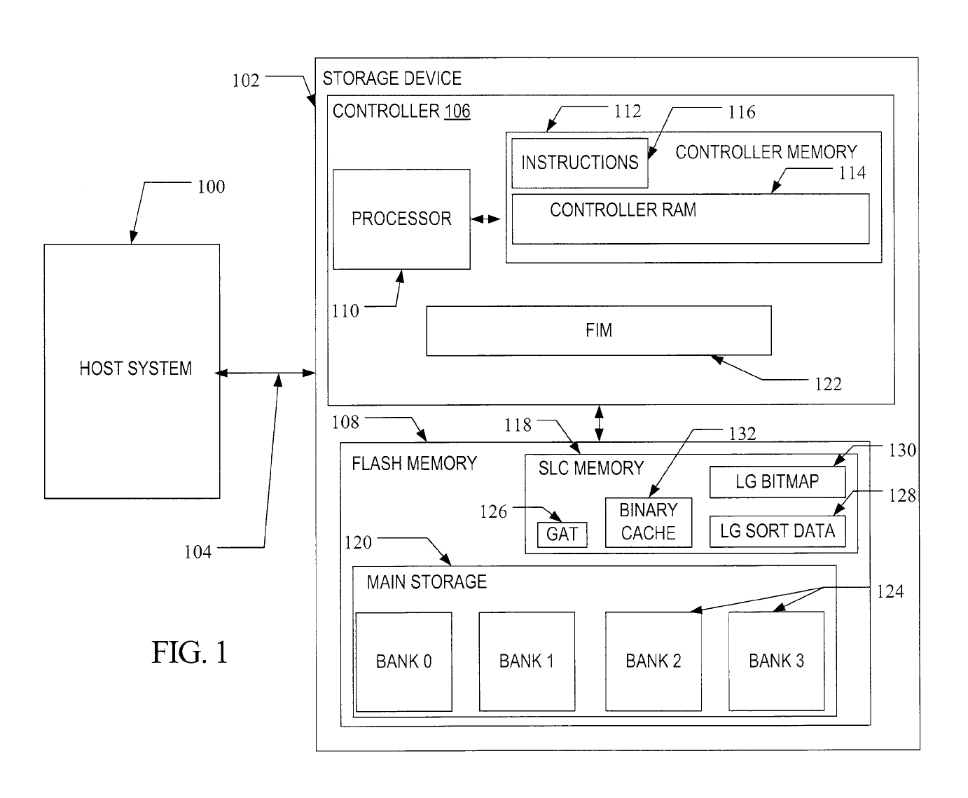

A flash memory system suitable for use in implementing aspects of the invention is shown in FIG. 1. A host system 100 stores data into, and retrieves data from, a storage device 102. The storage device 102 may be embedded in the host system 100 or may exist in the form of a card or other removable drive, such as a solid state disk (SSD) that is removably connected to the host system 100 through a mechanical and electrical connector. The host system 100 may be any of a number of fixed or portable data handling devices, such as a personal computer, a mobile telephone, a personal digital assistant (PDA), or the like. The host system 100 communicates with the storage device over a communication channel 104.

The storage device 102 contains a controller 106 and a memory 108. As shown in FIG. 1, the controller 106 includes a processor 110 and a controller memory 112. The processor 110 may comprise a microprocessor, a microcontroller, an application specific integrated circuit (ASIC), a field programmable gate array, a logical digital circuit, or other now known or later developed logical processing capability. The controller memory 112 may include volatile memory such as random access memory (RAM) 114 and/or non-volatile memory, and processor executable instructions 116 for handling memory management.

As discussed in more detail below, the storage device 102 may include functions for memory management. In operation, the processor 110 may execute memory management instructions (which may be resident in instructions 116) for operation of the memory management functions. The memory management functions may control the assignment of the one or more portions of the memory within storage device 102, such as controller memory 112. For example, memory management functions may allocate a portion of controller memory 112 for a data cache. One, some, or all of the memory management functions may be performed by one or separate elements within the storage device 102. The controller RAM 114 may include one or more data cache areas for use in optimizing write performance. The controller 106 may also include one of more flash interface modules (FIMs) 122 for communicating between the controller 106 and the flash memory 108.

The flash memory 108 is non-volatile memory and may consist of one or more memory types. These memory types may include, without limitation, memory having a single level cell (SLC) type of flash configuration, also known as binary flash, and multi-level cell (MLC) type flash memory configuration. The flash memory 108 may be divided multiple parts, for example an SLC memory 118 and a main storage area 120, where the main storage area 120 may be further divided into multiple banks 124. Although the banks are preferably the same size, in other embodiments they may have different sizes. The storage device 102 may be arranged to have a different FIM 122 designated for each bank, or more than one bank 124 associated with a FIM 122. Each bank 124 may include one or more physical die, and each die may have more than one plane. The SLC memory 118 may contain a logical group bitmap 130 which may contain a list of valid and invalid logical groups of data stored in the flash memory 108, along with a group address table (GAT) 126 which may contain the physical location information of the logical groups. The GAT 126 and logical group bitmap 130 may be stored in the SLC Memory 118 or in another location in the storage device 102. The SLC memory 118 may also maintain a binary cache 132 and, as described further below, logical group sort data 128. Although the flash memory 108 is shown as including SLC memory 118 outside of the individual banks 124, in other implementations each bank may instead include some SLC memory where each bank would include in its SLC memory a portion of the GAT relevant to that bank.

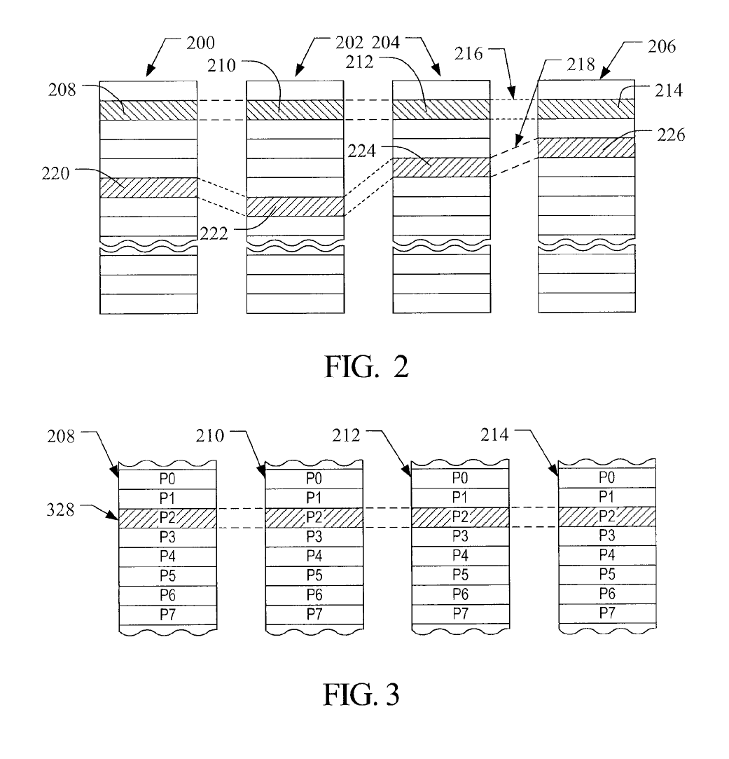

Each bank 124 of the flash memory 108 may be arranged in blocks of memory cells. A block of memory cells is the unit of erase, i.e., the smallest number of memory cells that are physically erasable together. For increased parallelism, however, the blocks may be operated in larger metablock units. One block from each of at least two planes of memory cells may be logically linked together to form a metablock. Referring to FIG. 2, a conceptual illustration of a bank 124 of a representative flash memory cell array is shown. Four planes or sub-arrays 200, 202, 204 and 206 of memory cells may be on a single integrated memory cell chip (also referred to as a die), on two chips (two of the planes on each chip) or on four separate chips. The specific arrangement is not important to the discussion below and other numbers of planes may exist in a bank. The planes are individually divided into blocks of memory cells shown in FIG. 2 by rectangles, such as blocks 208, 210, 212 and 214, located in respective planes 200, 202, 204 and 206. There may be dozens or hundreds of blocks in each plane. Blocks may be logically linked together to form a metablock that may be erased as a single unit. For example, blocks 208, 210, 212 and 214 may form a first metablock 216. The blocks used to form a metablock need not be restricted to the same relative locations within their respective planes, as is shown in the second metablock 218 made up of blocks 220, 222, 224 and 226.

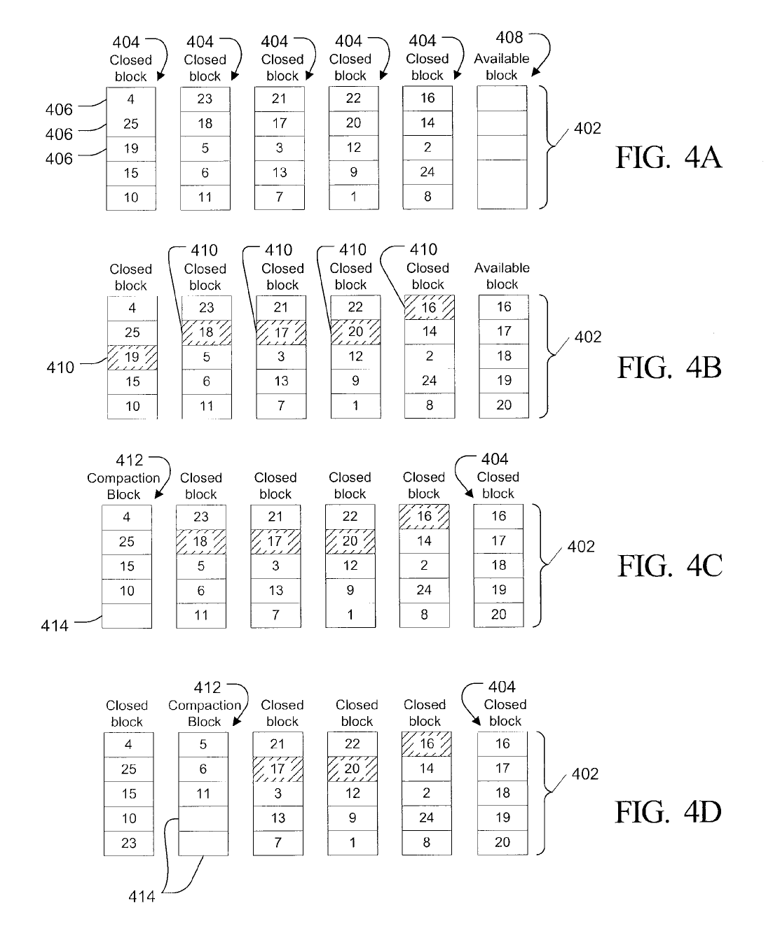

The individual blocks are in turn divided for operational purposes into pages of memory cells, as illustrated in FIG. 3. The memory cells of each of blocks 208, 210, 212, and 214, for example, are each divided into eight pages P0-P7. Alternately, there may be 16, 32 or more pages of memory cells within each block. A page is the unit of data programming within a block, typically containing the minimum amount of data that are programmed at one time. The minimum unit of data that can be read at one time may be less than a page. A metapage 328 is illustrated in FIG. 3 as formed of one physical page for each of the four blocks 208, 210, 212 and 214. The metapage 328 includes the page P2 in each of the four blocks but the pages of a metapage need not necessarily have the same relative position within each of the blocks. A metapage may be the maximum unit of programming. The blocks disclosed in FIGS. 2-3 are referred to herein as physical blocks because they relate to groups of physical memory cells as discussed above.

As used herein, a metablock is a unit of address space defined to have a range of logical addresses the same size as one or more physical blocks. Each metablock includes multiple logical groups (LGs) and each LG includes a range of logical block address (LBAs) that are associated with data received from a host 100. A logical group may refer to any of a number of logically related groups of data, such as a metapage or a certain number of metapages, a certain number of bytes of data or some other amount of data based on size that a data structure, such as the logical group bitmap 130 and the group address table (GAT) 126 in the SLC memory 118, or other location in the storage device 102, can track within a block.

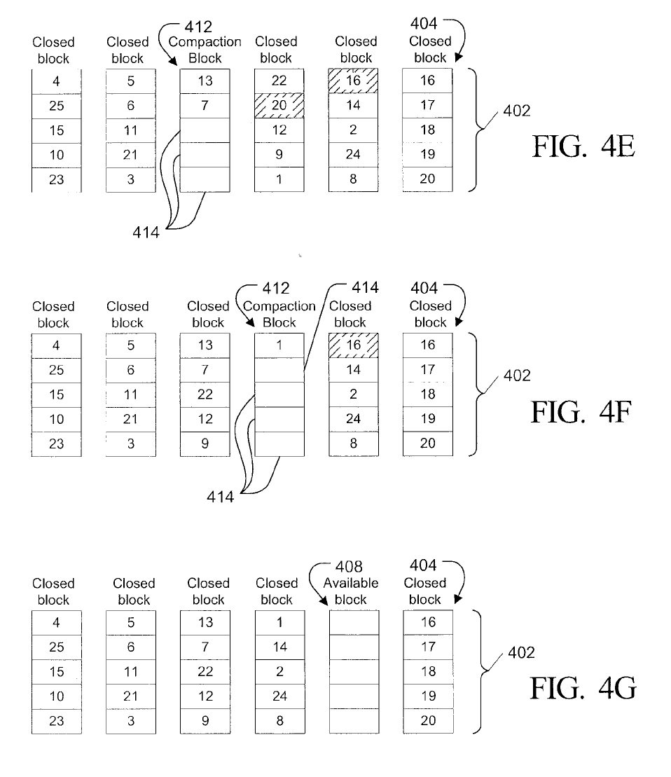

As noted earlier, over time data in a storage device may become fragmented, where sequentially numbered logical groups become scattered into non-contiguous physical locations in the main storage of the storage device. When this happens, and especially when the main storage comes full, a subsequent write of updated data for a sequential run of logical groups corresponding to those fragmented throughout different locations in the main storage can lead to multiple housekeeping steps to remove the invalid data from each of the different locations to make a new free block for subsequent data writes. Referring to FIGS. 4A-4G, a simplified hypothetical sequence of activity surrounding a data write to main storage of a storage device is shown, including the subsequent housekeeping steps that may be necessary in a storage device that does not implement the logical group sorting technique described herein. The added housekeeping steps may be due to the fragmentation problem in a small logical group based architecture where sequential data is no longer contiguous within a metablock. When a large write command comes in and the storage device is full, the storage device may require many back-to-back MLC compactions to free up space because the obsolete old data can be scattered over many MLC blocks. The large number of MLC compactions can lead to a long command response time.

An example of the type of situation that can result in long response times is shown in FIGS. 4A-4G. In FIG. 4A an array of blocks 402 in a main storage, such as MLC flash memory, is shown when a storage device is substantially full. In this initial stage, the majority of closed blocks 404 contain logical groups 406 that are non-sequentially numbered where a number of sequential logical groups are scattered across different blocks. One free block 408 is shown that may receive new data being written to the main storage. In this situation, when a long write command comes in with updates to logical groups that span across multiple sequential logical groups, for example 5 logical groups (logical groups 16-20) to simplify this illustration, the previous instances of those logical groups now contain obsolete data. In FIG. 4B, the updated logical groups have been written to the formerly free block 408 and the obsolete data 410 in the closed blocks 404 is illustrated with cross-hashing to show how five separate blocks are affected by the data write due to the fragmentation of this particular sequence of logical groups.

Assuming that the memory is substantially full, in this example five separate compaction operations are needed to free up space for the next write (to free up a block with five logical groups of space). This sequence of compaction steps is illustrated in FIGS. 4C-4G. Compaction is an internal housekeeping process of taking valid data already in the main storage, copying any valid data from a completed block (i.e., a previously fully written block that is now closed but has had some data made obsolete by updated information stored in another block), and writing only the valid data into a new block, also referred to as a compaction block 412, so the previous block can be erased and reused. In one implementation of the compaction process, the controller would typically first select the block with the least amount of valid data and continue the process in that manner. In the idealized example of FIGS. 4A-4G, each block has a single obsolete logical group so the process of compaction is shown progressing sequentially through the different blocks. Thus, in FIG. 4C, the valid data may be copied to a new block with one free logical group 414 (for example a metapage) available for the next write operation. In FIG. 4D, the second block is compacted, copying the first valid logical group in to the unwritten space of the first compacted block and the remainder into a new block leaving space for two free logical groups. The process of compacting each of the affected blocks continues in FIGS. 4E-4G until an entire block of free space is freed up. In this example, one write led to five separate compaction steps to free up a new block because the sequentially numbered set of logical groups (16-20) that were updated as part of a write to the main storage were discontiguously located in five separate different blocks.

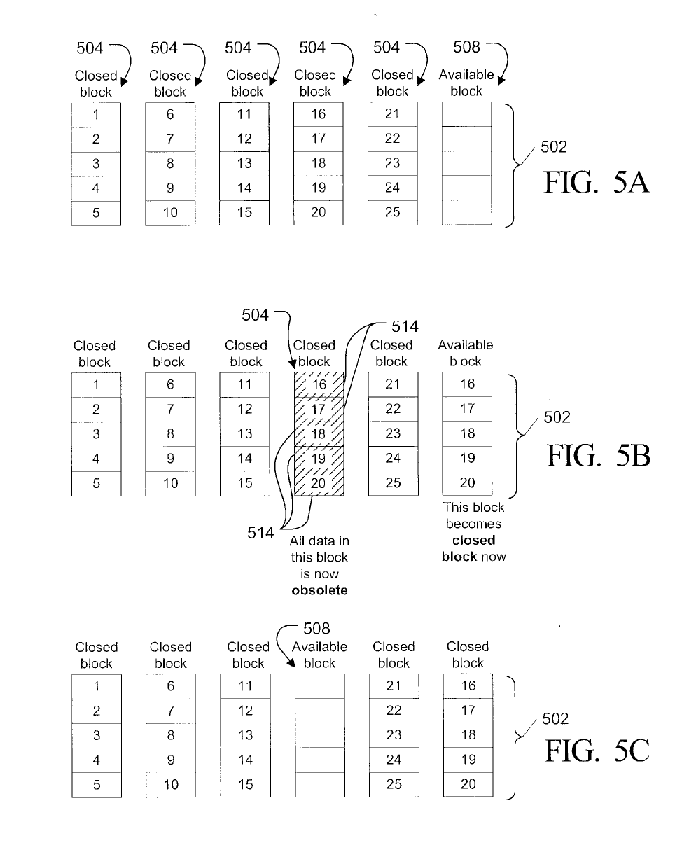

In contrast, a logical group sorting technique as disclosed herein may greatly reduce the fragmentation of logical groups in the memory and thus reduce the number of housekeeping steps needed to free up additional blocks. An example of a set of blocks 502 in main storage, for example MLC flash memory, with pre-sorted logical groups is illustrated in FIGS. 5A-5C. In FIG. 5A, the logical groups have been maintained in sequential order and are contiguously located in blocks. Referring to FIG. 5B, when data is written to this memory, for example the same run of logical groups 16-20 as used in the prior illustration of FIGS. 4A-4G above, only one block in the memory contains obsolete data. The controller of the storage device may then simply erase the block with the obsolete data to free up a new block, as shown in FIG. 5C, without having to do any compaction operations. Although the examples of a memory without sorted logical groups (FIGS. 4A-4G) and one with sorted logical groups (FIGS. 5A-5C) are simplified and idealized examples, the potential benefits of presorting the data are apparent. A storage device that is becoming full and needs to write a relatively long run of data corresponding to sequentially numbered logical groups may reduce the number of housekeeping operations needed when the memory is sorted as compared to an unsorted memory.

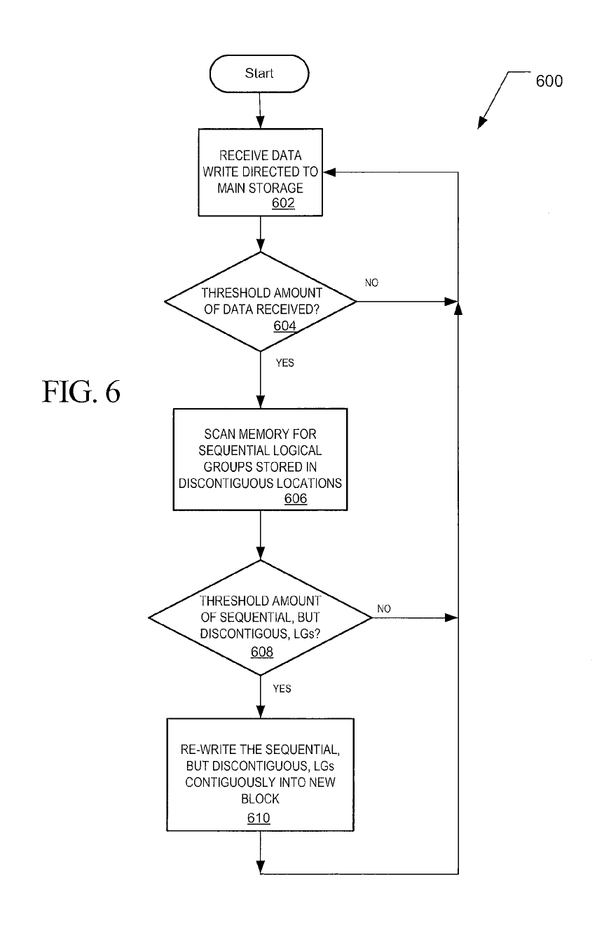

In order to achieve increased sorting of logical groups in memory, a method 600 of managing the memory of a storage device is illustrated in FIG. 6. This method may utilize the storage device 102 of FIG. 1, and be implemented based on hardware, firmware or software, for example processor executable instructions maintained in controller memory 112 or elsewhere, in the storage device 102. Referring to FIG. 6, a data write is received for writing to the main storage 120 of the flash memory 108 (at 602). The data write may be sequentially ordered logical groups received from any source, external or internal to the storage device. Examples of data writes include sequential host writes containing sequentially ordered logical groups received directly from the host system 100 and directed by the controller 106 to main storage, eviction of data from the binary cache 132 to the main storage 120, a binary working set (BWS) folding operation internal to the storage device 102, or any other source of sequential data (or a very long random write command that appears to the storage device to be sequential) for writing to the MLC blocks in main storage 120.

Upon receipt of data for writing to the main storage, the controller 106 determines if a threshold amount of data directed to the main storage 120 has been received and, if the threshold amount of data has been received, scans the main storage to see how many sequentially numbered logical groups are present in the main storage that are discontiguously located (at 604, 606). In one embodiment, if a block is found having a range of sequentially numbered logical groups, but non-sequentially ordered within the block (for example logical group numbers 1-5 are present, but stored 1, 3, 5, 2, 4 in the block) that range would not be considered to contain discontiguous LGs and would not be counted in the discontiguous LG count. The threshold amount of data received may be a fixed, preset amount in one embodiment, or it may be an amount that varies depending on a state of the storage device in another embodiment. The threshold amount of data received may be tracked as a cumulative amount such that, after the threshold is reached and the memory is scanned, the controller then restarts a tally of received data until the next cumulative amount of received data reaches the threshold triggering the next scanning process. Accordingly, the threshold amount of data received affects the frequency at which the memory is scanned. If the threshold amount of data has not yet been received, the controller writes the received data to the main storage and continues to monitor the cumulative amount of received data (at 604, 602).

When scanning the main storage 120 to determine the number of fragmented logical groups, the controller 106 is looking for logical groups that are sequentially numbered but stored in discontiguous locations, such as in different blocks, in the main storage (at 606). If a threshold amount of sequential but discontiguous logical groups are identified, the controller 106 will then take that threshold number of logical groups and copy them into a new block (at 608, 610). In one embodiment, the sequential logical groups found as discontiguously located throughout the main storage 120 of the memory 108 are copied in sequential order contiguously into the new (free) block. If the scan of the main storage 120 does not turn up the threshold amount of fragmentation, then the process repeats once a next threshold amount of data is received (at 608, 602).

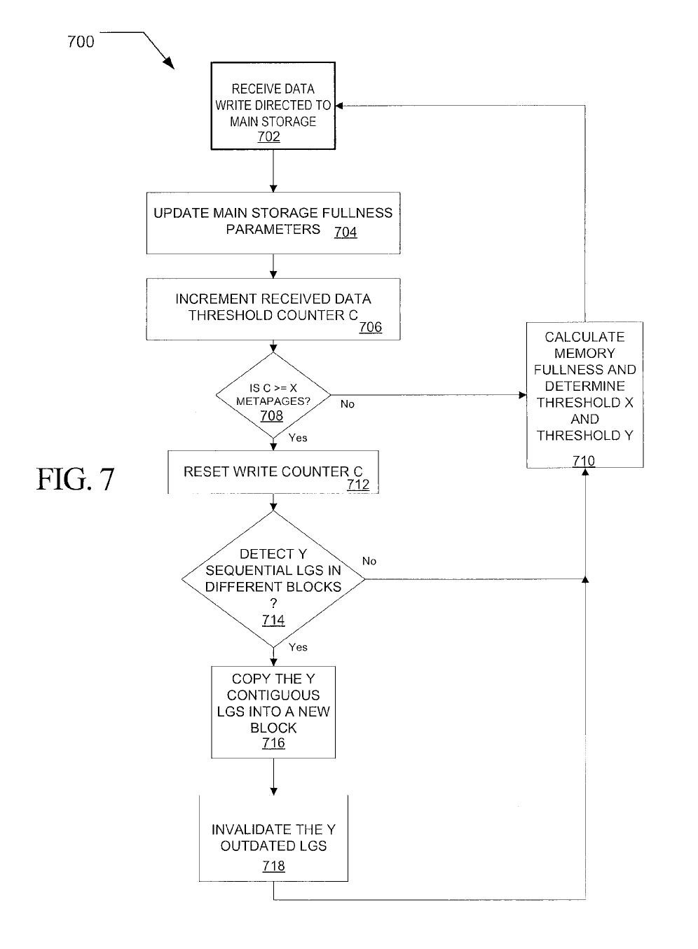

Another embodiment of the method of FIG. 6 is illustrated in FIG. 7. In the method 700 of FIG. 7, the storage device fullness is determined and used to vary the threshold amount of received data needed to trigger a scanning and re-ordering of the logical groups in the main storage 120. Upon receiving data writes directed to main storage 120 (at 710), the controller 106 updates memory fullness parameters and increments a counter that is used to determine when a sufficient amount of data has been received to trigger a scan of the memory (at 704, 706). The memory fullness parameters may include a counter A containing a running total of the number of logical groups of data received by the storage device, as well as a counter B containing the total number of logical groups that have been made obsolete in the memory. Although described in this example as tracking a number of logical groups, counter A may track logical groups, metapages, or some other increment of received data in other implementations. Counters A and B may be used to determine a fullness of the storage device, as described in more detail below. A received data threshold counter C, which is used to control fragmentation detection frequency, is updated to keep track of when a next scan for sequential, but discontiguous logical groups in the main storage. The counters may be maintained in controller RAM, or in the flash memory 108 to protect against power loss, or based on RAM capacity issues. As noted below, the counters may be stored with logical group sort data 128 in the SLC memory 118.

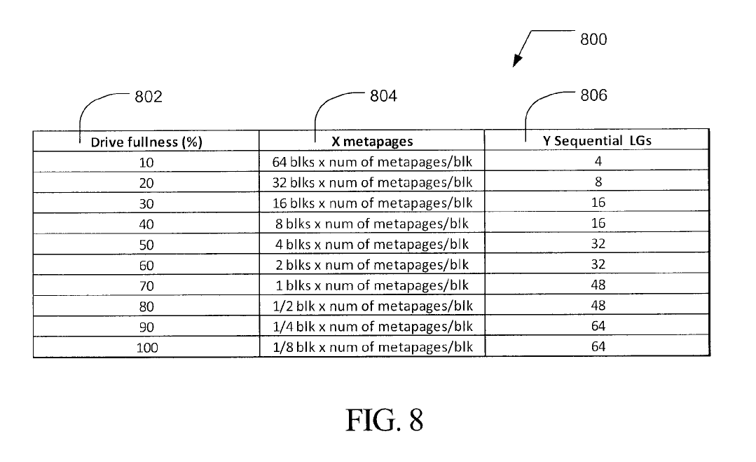

After data is received and the counters updated, the received data threshold counter C may be compared to the current threshold X (at 708). The threshold X may be fixed as noted previously or may be dynamic as is described herein. If the received data threshold counter C is less than the threshold X, then the fullness of the main storage is determined and the threshold X may be adjusted based on the current fullness. Additionally, the threshold number of sequential but discontiguous logical groups (Y) may also be adjusted based on the drive fullness (at 710). The process of receiving data to be written to main storage, updating the main storage fullness parameters and incremented the received data threshold counter is then repeated until the counter C is equal to or greater than threshold X. The threshold X may be set at an initial default amount and then adjusted according to changes in fullness of the storage device. The adjustments may be based on an algorithm or simply looked up from a data structure, such as a table as shown in FIG. 8.

If the received data threshold counter C is greater than the threshold X, then counter C is reset and the controller scans the main storage to detect the number of sequential, but discontiguously stored logical groups (at 712, 714). For example the controller 106 may scan the main storage by scanning the logical group bitmap 130 maintained in the SLC Memory 118 to determine if logical group data is valid and then scanning the GAT 126 to determine the physical location of each logical group in the main memory 120. A fixed or variable threshold number (Y) of sequentially numbered, but discontiguously stored logical groups may be compared against the number that were determined by scanning the main storage (at 714). The main storage may be formed of blocks of MLC flash arranged in one of more banks as illustrated in FIG. 1. If the number of detected sequential, discontiguous logical groups is less than the threshold Y, then the controller determines the memory fullness and any necessary updates to the thresholds X,Y and repeats the process of receiving data and awaiting the next threshold amount of data. If the number of sequential and discontiguous logical groups found in scanning the main memory meets or exceeds the threshold Y, then that number of logical groups that meets or exceeds the threshold amount is copied into a new block in the main memory in sequence and contiguously (at 716). The original logical groups are then invalidated (made obsolete) in the various blocks that the logical groups were copied from (at 718). The various drive fullness and thresholds may then be recalculated (at 710) and the process repeated continuously to maintain a more ordered arrangement of logical groups in physical storage locations in the main storage.

The main storage area fullness may be calculated in a number of ways. In one embodiment, the main storage fullness may be calculated by subtracting the amount of invalidated (obsolete) data from the amount of data written to main storage, for example by subtracting counter B from counter A as described above. This amount may be calculated as a percentage fullness of the main storage and then used to reference a table or calculate an algorithm for adjusting one or more of the threshold amount of received data to trigger a scan of the memory (i.e. threshold X in FIG. 7) and the threshold amount of sequential, but discontiguous logical groups found in the scan of the memory that triggers a sequential, contiguous copy of logical groups to a new block (i.e. threshold Y in FIG. 7).

An example of a table implementation is illustrated in FIG. 8. The table 800 in FIG. 8 sets out, by the fullness 802 of the main storage, a variable threshold X 804 and a variable threshold Y 806 that change based on the fullness 802. In the example of FIG. 8, the threshold X 804 to trigger the scan decreases as the fullness of the main storage increases. Although threshold X is showing a data threshold in terms of metapages, other data increments may be used. The threshold Y number of sequential, but discontiguous logical groups needed to trigger a copy to a new block is illustrated as increasing as the main memory fills up. The logical group sort data 128, which may include some or all of the table 800, along with the counters, thresholds, storage device fullness calculations and any other parameters used or calculated as part of the adaptive logical group sorting processes described, may be stored in flash memory 108, in controller memory or in any of a number of locations in the storage device 102.

In alternative embodiments, only one of the thresholds (X, Y) may be variable based on memory fullness and the other may be fixed. Also, criteria other than fullness, or in addition to fullness, may be used to alter one or both thresholds. In other implementations, the change in the threshold or thresholds may be non-linear, for example weighted to change more rapidly or at different increments as the memory becomes more or less full. The threshold amount of data received (X) may also be varied based on an algorithm or table that is completely different than the threshold number of sequential but discontiguous logical groups. Also, the number of sequential, but discontiguous logical groups re-written to a new block or blocks may be equal to or great than actual threshold number (Y) that triggers a re-write in sequential contiguous order. The controller may also look for all collections of sequential, but discontiguous logical groups that meet the current threshold (Y) during a scan or just the first such collection of sequential, but discontiguous logical groups that meets the threshold.

Depending on the size of the blocks used in the storage device and the current threshold number of logical groups that is being scanned for, a write of sequential logical groups to a new block may not completely fill up a new block or a whole number of new blocks. In one implementation, the controller may then write dummy data to fill up the remainder of the new block and avoid further fragmentation. In another implementation, the controller will not write dummy data and will instead use any remaining space in the new block for use in the next host write. Also, in other embodiments, the scanning of the main storage for fragmentation (sequential but discontiguously stored logical groups) and/or the act of re-writing the fragmented logical groups sequentially and contiguously in one or more new blocks, may be part of a larger memory management scheme that prioritizes garbage collection and other housekeeping operations to maintain a desired level of performance for the storage device.

The method and system described above for adaptively sorting logical groups to prevent or reduce fragmentation may be implemented on a removable or standalone storage device or memory embedded in a host. The techniques for implementing the scanning and sorting process may be implemented in hardware, or as software or firmware executable by a processor of the storage device.

An advantage of the disclosed method and system is that write performance may be improved where write amplification is reduced and a higher percentage of time may be spent on writing data rather than making room for data. For example, as illustrated in FIGS. 4A-4G, a memory that is not sorted and that receives a long data write of sequential data, may need to spend an excessive amount of time executing multiple data compaction steps to free space as the memory fills up. In contrast, as illustrated in FIGS. 5A-5C, pre-sorting of logical groups, such as by the techniques disclosed herein, can reduce the need for compaction or other housekeeping operations to make sure blocks may be freed up for subsequent writes.

A system and method has been disclosed for improving write performance in a storage device by reducing fragmentation in the memory. According to one embodiment a controller may, after a threshold amount of data has been received, scan the memory for sequentially numbered, but discontiguously stored logical groups. When a threshold number of sequential, but discontiguous logical groups are discovered in a memory scan, they may be re-written in sequence and contiguously into one or more free blocks. The disclosed system and method may adapt the rate of scanning and the trigger amount of fragmented data to account for a status of the storage device, such as the fullness of the main storage.

It is therefore intended that the foregoing detailed description be regarded as illustrative rather than limiting, and that it be understood that it is the following claims, including all equivalents, that are intended to define the spirit and scope of this invention.

What is claimed is:

1. A method of controlling storage of content on a storage device, the method comprising:
in a storage device having a controller in communication with non-volatile memory:
receiving data for storage in the non-volatile memory;
determining if a threshold amount of data has been received; and
if the threshold amount of data has been received:
scanning the non-volatile memory for sequentially numbered logical groups of data previously written in noncontiguous locations in the non-volatile memory; and
if a threshold amount of sequentially numbered logical groups previously written in noncontiguous locations are present, re-writing at least the threshold amount of sequentially numbered logical groups of data contiguously into a new block in the non-volatile memory.

2. The method of claim 1, wherein the threshold amount of data received comprises a fixed, preset amount of data.

3. The method of claim 1, wherein the threshold amount of sequentially numbered logical groups previously written in noncontiguous locations comprises a fixed, preset amount of logical groups of data.

4. The method of claim 1, wherein the threshold amount of sequentially numbered logical groups previously written in noncontiguous locations comprises a variable amount of logical groups of data, wherein the variable amount is dependent on a state of the non-volatile memory.

5. The method of claim 4, wherein the state of the non-volatile memory comprises a fullness of the non-volatile memory.

6. The method of claim 5, wherein the threshold amount of sequentially numbered logical groups increases as the fullness of the non-volatile memory increases.

7. The method of claim 1, wherein the threshold amount of data received comprises a variable amount of data, wherein the variable amount is dependent on a state of the non-volatile memory.

8. The method of claim 7, wherein the state of the non-volatile memory comprises a fullness of the non-volatile memory.

9. The method of claim 8, wherein the threshold amount of received data decreases as the fullness of the non-volatile memory increases.

10. A storage device comprising:
a non-volatile memory; and
a controller in communication with the non-volatile memory, the controller configured to:
receive data for storage in the non-volatile memory;
determine if a threshold amount of data has been received; and
if the threshold amount of data has been received:
scan the non-volatile memory for sequentially numbered logical groups of data previously written in noncontiguous locations in the non-volatile memory; and
if a threshold amount of sequentially numbered logical groups previously written in noncontiguous locations are present, re-write at least the threshold amount of sequentially numbered logical groups of data contiguously into a new block in the non-volatile memory.

11. The storage device of claim 10, wherein the threshold amount of data received comprises a fixed, preset amount of data.

12. The storage device of claim 10, wherein the threshold amount of sequentially numbered logical groups previously written in noncontiguous locations comprises a fixed, preset amount of logical groups of data.

13. The storage device of claim 10, wherein the threshold amount of sequentially numbered logical groups previously written in noncontiguous locations comprises a variable amount of logical groups of data, wherein the variable amount is dependent on a state of the non-volatile memory.

14. The storage device of claim 13, wherein the state of the non-volatile memory comprises a fullness of the non-volatile memory.

15. The storage device of claim 14, wherein the threshold amount of sequentially numbered logical groups increases as the fullness of the non-volatile memory increases.

16. The storage device of claim 10, wherein the threshold amount of data received comprises a variable amount of data, wherein the variable amount is dependent on a state of the non-volatile memory.

17. The storage device of claim 16, wherein the state of the non-volatile memory comprises a fullness of the non-volatile memory.

18. The storage device of claim 17, wherein the threshold amount of received data decreases as the fullness of the non-volatile memory increases.

19. A method of controlling storage of content on a storage device, the method comprising:
in a storage device having a non-volatile memory and a controller in communication with the non-volatile memory, the controller:
receiving data comprising data to be written to the non-volatile memory;
incrementing a data write counter an amount corresponding to an amount of the data to be written;
scanning the non-volatile memory for sequentially numbered, but discontiguously located, logical groups when the data write counter reaches or exceeds a scan threshold amount;
if a number of sequentially numbered, but discontiguously located, logical groups stored in the non-volatile memory identified by scanning the non-volatile memory is at least equal to a contiguous write threshold, copying the sequentially numbered logical groups contiguously into a new block in the non-volatile memory; and
after copying the sequentially numbered logical groups contiguously into the new block, invalidating the sequentially numbered logical groups in their respective original blocks.

20. The method of claim 19, further comprising:
Decreasing the scan threshold amount and increasing the contiguous write threshold as a fullness of the non-volatile memory increases.
